(19) United States
(12) Patent Application Publication
(10) Pub. No.: US 2003/0061117 A1
(43) Pub. Date: Mar. 27, 2003

(54) Instrument exchanging system, instrument exchanging method, and instrument performance evaluation program

(75) Inventor: Susumu Onodera, Tokyo (JP)

Correspondence Address: McGinn & Gibb, PLLC, Suite 200, 8321 Old Courthouse Road, Vienna, VA, 22182, US

(73) Assignee: NEC Corporation, Tokyo (JP)

(21) Appl. No.: 10/254,522

(22) Filed: Sep. 26, 2002

(30) Foreign Application Priority Data
Sep. 26, 2001 (JP) 2001-293082

(51) Int. Cl. G06F 17/60

(52) U.S. Cl. 705/26

(57) ABSTRACT

In an instrument exchanging system, a terminal of an user who has a PC and hopes the exchange of the PC, a terminal of an arrangement center which arranges the exchange of the PC, a terminal of a recycling processing center which supplies the PC to be exchanged, and a terminal of a delivery center are all connected through a communication network. The terminal of the arrangement center has, means for providing the user with performance evaluation software to evaluate a performance of PC, means for receiving the result of performance evaluation acquired automatically by the performance evaluation software, information inputted by the user and specifying the user, and information of expanding functions of PC, means for selecting PC of a performance suitable for each user's using condition with reference to the result of performance evaluation and the information inputted by a plurality of users, means for creating proposed specifications from selected kind of PC, and means for providing the user with the user with the proposed specifications. The stocked PC or newly purchased one is arranged while the PC of the user is collected.

### BACKGROUND OF THE INVENTION

The present invention relates to an instrument exchanging system and instrument exchanging method, and instrument performance evaluation program, in particular to instrument exchanging system, instrument exchanging method, and instrument performance evaluation program which are capable of exchanging an instrument having an arithmetic processing function, such as a personal computer (hereafter, called PC) in response to using condition of an user.

An application software of PC has been made multi-functioned year after year by the version-up thereof. Further, data file of an anti-virus software is expanded while a detector engine of the anti-virus software is improved to corresponded to virus going on increasing. A processing ability of PC is declined for operations that an user want to do, because the version-up and the improvement of detector engine generally lead to increase loading in processing of the PC. Therefore, even if the user uses the same PC to do the same operation, the user inevitably feels the shortage of a performance of PC as time passes.

When the user feels dissatisfaction of a performance of his PC, the user needs to buy another PC of higher performance. But, the user doesn't always need to buy a new PC. If the user can be satisfied with secondhand goods that someone used, the user buys the secondhand goods from secondhand stores of PC or individually buys the secondhand goods using an auction cite on an Internet for individuals.

Conventionally, on the occasion of using a secondhand salesman of PC by the Internet, the user investigates specifications of PC for his own need and then orders the PC. It is necessary for the user to request acquisition of the PC that the user has used until then using a trade-in service. However, there is no example that a dealer receives an order and an acquisition request of PC simultaneously. Therefore, the order and the acquisition request of PC are to be performed separately.

Further, on the occasion of using the auction cite for individuals, the user investigates specifications of PC for his own need and then searches whether or not such a PC is exhibited in the action cite. In addition, the user enters his PC that has been used until then on the auction cite. In that case, similarly to the case using the secondhand salesman of PC, there is no example that both purchase and sale of PC can be received simultaneously in the auction cite. According, there was no guarantee that both the purchase and the sale are concluded certainly.

Furthermore, in any of the above cases, it is necessary for the user to have the advanced knowledge about PC in considering the specifications of PC required for himself. When the knowledge of the user about PC is short, a PC having a high performance to unnecessary extent was purchased to spend an excessive money. On the contrary, a PC having an insufficient performance was purchased, so that dissatisfaction for the performance remains.

Under the circumstances, desired is such a service that specifications of PC having necessary and sufficient, performance is shown to the user and the user can replace the PC with a new PC having a performance equivalent to the specifications of necessary and sufficient performance, when the user feels a shortage of performance of PC.

### SUMMARY OF THE INVENTION

To solve the above-described problems, the present invention provides, an instrument exchanging system for use in comprising, a user's terminal having at least the instrument which wish to exchange, a terminal of arrangements center that arranges exchanging of instrument, a terminal of recycling processing center which supplies the instrument to exchange and a terminal of delivery center that recovery the instrument which the user have and deliver the instrument to exchange are connected through a communication network. And the present invention provides, an instrument exchanging system for use in comprising, in the terminal of arrangements center, means for receiving at least the performance evaluation information of instrument obtained by performance evaluation program to evaluate performance of instrument and the information inputted by user, means for selecting PC of a performance suitable for each user's use condition and creating the exchanging condition information referencing to the performance evaluation information and the inputted information of a plurality of user, means for providing user with the exchanging condition information.

According to an aspect of the present invention, it can consider as composition that the performance evaluation program, which is implemented on the instrument the user having, is transmitted from the terminal of arrangements center to the user's terminal, and is provided the user with the form recorded on the recording medium.

And according to an aspect of the present invention, it is preferable that the load value of CPU of instrument or the used amount of the memory means is included in performance evaluation information.

Further, according to an aspect of the present invention, it can consider as composition for including the information of extended function which the user wishes in the inputted information.

Moreover, according to an aspect of the present invention, it is preferable that the instrument comprises computer instrument or portable terminal.

The present invention provides an instrument exchanging method, at least which is connected through a communication network with the userVs terminal having the instrument which wishes to exchange and the terminal of the arrangements center which arranges exchanging of the instrument, in the terminal of arrangements center, the step of receiving the instrument exchanging demand from the user, the step of receiving the performance evaluation information on the instrument acquired by the performance evaluation program which evaluates the performance of the instrument and the information inputted by the user, the step of selecting the instrument of a performance suitable for each userVs operating condition with reference to performance evaluation information and inputted information of a plurality of user and creating the exchanging condition information, the step of providing user with the exchanging condition information. When these steps have implemented and the user has consented to the exchanging condition, the instrument is exchanged.

According to an aspect of the present invention, it can consider as composition, which the arrangements center transmitted the performance evaluation program from the terminal of the arrangements center to the user's terminal, or which the user is provided with the form was recorded on the recording medium.

Moreover, according to an aspect of the present invention, both the terminal of a recycling processing center to supply the instrument and the terminal of a delivery center are connected through the communication network, in the recycling processing center, when the instrument which exchanging is not materialized between the instrument which a plurality of users offer, and correspondent instrument in this recycling processing center is not being kept, new supply of this instrument can be performed and performs recovery of the instrument which the user have, and delivery of a exchanging instrument in the delivery center.

Furthermore, according to an aspect of the present invention, it is preferable that the performance evaluation program is implement by the user who obtained this performance evaluation program on the instrument which the user wishes to exchange during predetermined time, the use condition of the instrument being supervised by the performance evaluation program, memorized, and the performance evaluation information being created.

In the instrument exchanging service of the present invention, the performance of instrument which the user wishes to exchange is automatically evaluated by the instrument exchanging method, and while the instrument suitable for this userVs operating condition is supplied, recovery of the instrument which this user have on the occasion of exchanging of instrument may be performed.

Furthermore, performance evaluation program of the present invention is to implement computer instrument, within predetermined time, processing to supervise the load condition of CPU, processing to collect frequency distribution of the load condition of CPU after predetermined time have passed, processing to compute frequency of the load condition of CPU beyond the threshold, processing to determine performance of CPU correspondence to predetermined userVs operating condition compared this computing value with predetermined table.

According to an aspect of the present invention, it is preferable that the table comprise a correspondence table of the performance of required CPU calculated by experiment with the rate of load condition exceeds the predetermined threshold value.

Thus, by the composition in this invention, even if it is the case where user does not have the advanced knowledge concerning instrument, in order that a performance evaluation program may evaluate the performance of instrument of wishing to exchange automatically, so long as user checks the exchanging condition information which the server of an arrangements center presents, user becomes exchangeable to suitable instrument.

And if the desired instrument may not be offered from another user, new instrument is supplied by supply center, user can exchange desired instrument certainly. In that case recovery of user's having instrument is performed, time and effort is saved to arrange both recovery of user's having instrument and delivery of desired instrument separately. Consequently, the conventional problems can be solved.

### BRIEF DESCRIPTION OF THE DRAWINGS

FIG. 1 is a diagram for showing the composition of an instrument exchanging system in a preferred embodiment of the present invention;

FIG. 2 is a diagram for showing the composition of the terminal of an arrangement center;

FIG. 3 is a diagram for showing the process of an instrument exchanging method in the preferred embodiment;

FIG. 4 is a flow chart for showing the operation of performance evaluation program provided to the user; and

FIG. 5 is a diagram for showing an example of the load condition of CPU

### DETAILED DESCRIPTION OF THE PREFERRED EMBODIMENTS

In an instrument exchanging system according to a preferred embodiment of the present invention, a terminal of an user who has a PC and hopes the exchange of the PC, a terminal of an arrangement center which arranges the exchange of the PC, a terminal of a recycling processing center which supplies the PC to be exchanged, and a terminal of a delivery center are all connected through a communication network. The terminal of the arrangement center has, means for providing the user with performance evaluation software to evaluate a performance of PC, means for receiving the result of performance evaluation acquired automatically by the performance evaluation software, information inputted by the user and specifying the user, and information of expanding functions of PC, means for selecting PC of a performance suitable for each user's using condition with reference to the result of performance evaluation and the information inputted by a plurality of users, means for creating proposed specifications from selected kind of PC, and means for providing the user with the prosed specifications. When the user consents to the proposed specification, a stocked or a newly purchased PC is supplied by the recycling processing center, then recovery of the user's PC and delivery of the PC for exchange are carried out by the delivery center.

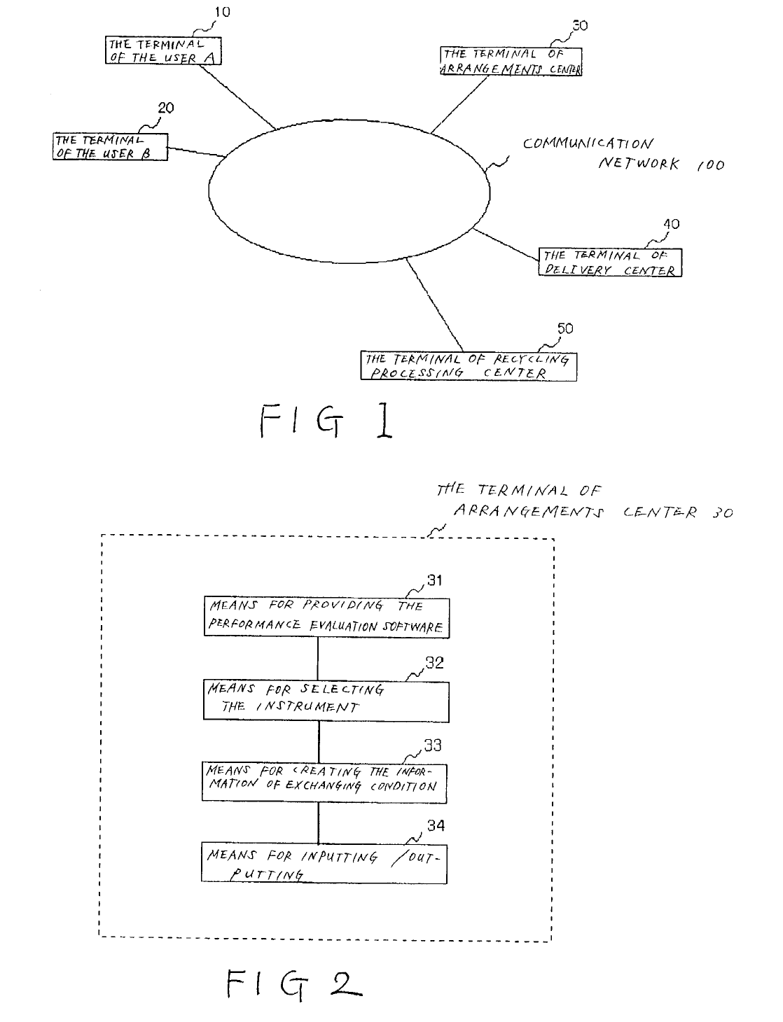

Referring to FIG. 1, the user A or the user B, using his own terminal 10 or 20, downloads performance evaluation software from an arrangement center terminal 30 through a communication network 100. Further, when this performance evaluation software is implemented in a PC of which exchange is wished, the performance evaluation software evaluates automatically the load environment at the time of operation of the own PC. Thereafter, exchange proposing information including the evaluation information is transmitted to the arrangement center terminal 30 through a communication network 100.

The arrangement center terminal 30 receives the exchange proposing information from a plurality of users, and then calculates the proposal specifications per each user. Further, the arrangement center terminal 30 shows each user the proposal specifications through the communication network 100, and then asks for consent of the user. If the consent of each user is obtained through the communication network 100, the arrangement center terminal 30 determines a suitable exchanging condition among them. Further, the arrangement center terminal 30 determines the specification of PC which should be newly arranged, if necessary, and the disposal of unnecessary PC. The arrangement center terminal 30 then transmits the exchanging condition information to a recycling processing center terminal 50.

Based on the exchanging condition information transmitted to the recycling processing center terminal 50, a recycling processing center carries out arrangements and warehousing of a new PC, if necessary, and transmits both the delivery directions of a new PC to the user and the directions of taking over a PC which has been used by the user from the recycling processing center terminal 50 to a delivery center terminal 40.

Based on the delivery directions and the directions of taking over the PC, a delivery center delivers the PC from the recycling processing center to the user, and takes over the PC from the user to the recycling processing center. Upon receiving the PC from the user, the recycling processing center inspects the PC and transmits the notice of completion from the recycling processing center terminal 50 to the arrangement center terminal 30. An arrangement center carries out settlement-of-accounts processing, when the arrangement center has received the notice of completion.

In this way, by downloading and implementing the performance evaluation software, the user lets the load environment of his own PC at the time of operation be evaluated automatically. The user can obtain necessary information for the PC, even if he has no special knowledge about PC. Further, the arrangement center selects and arranges PC fitted for each user's operating condition, only by transmitting the exchange proposing information including the evaluation information to the arrangement center. In addition, the arrangement center takes over an unnecessary PC and carries out a suitable disposal of the unnecessary PC. It is not necessary for the user himself to carry out processing, such as selection, order, taking over, and the like. As a result, convenience of the user can be improved.

[Embodiment ]

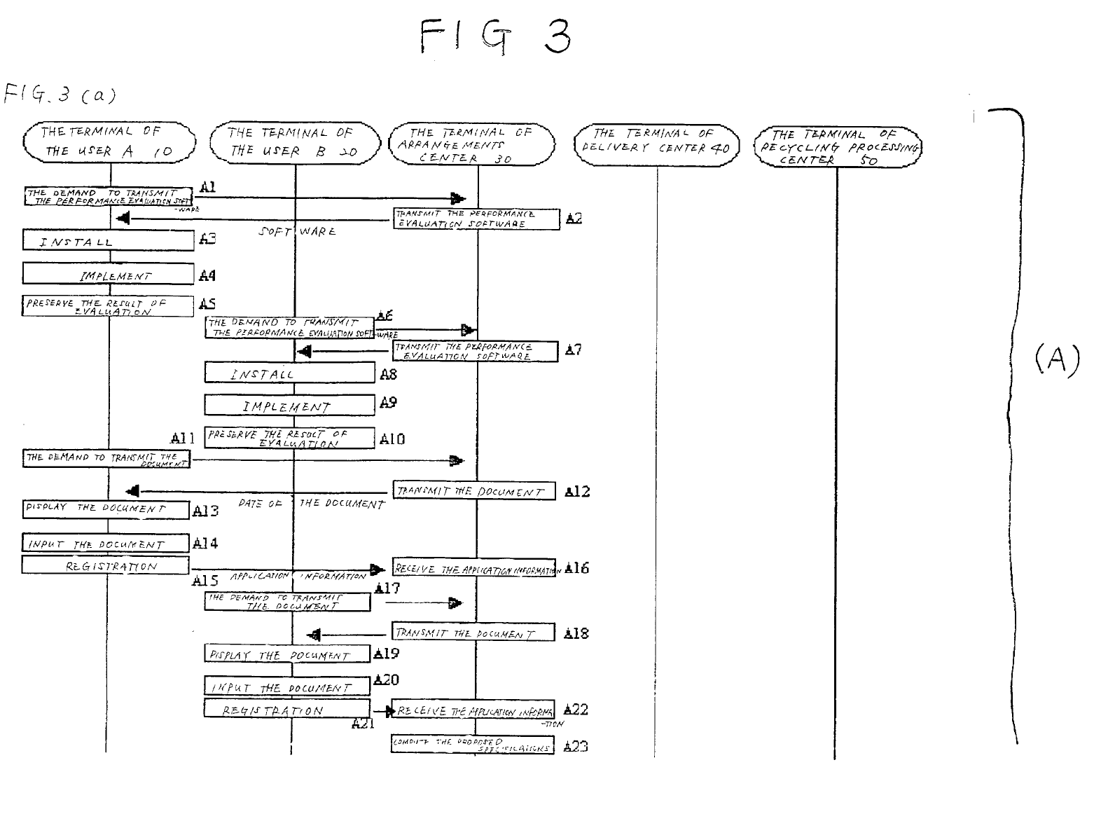

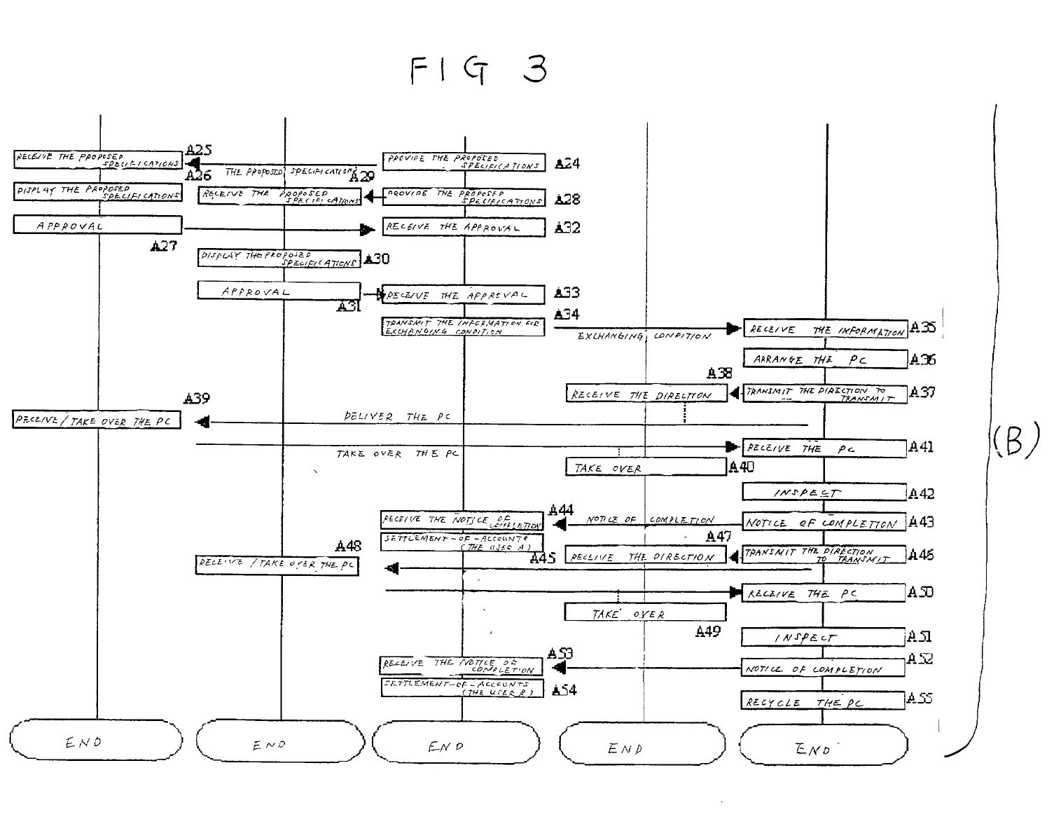

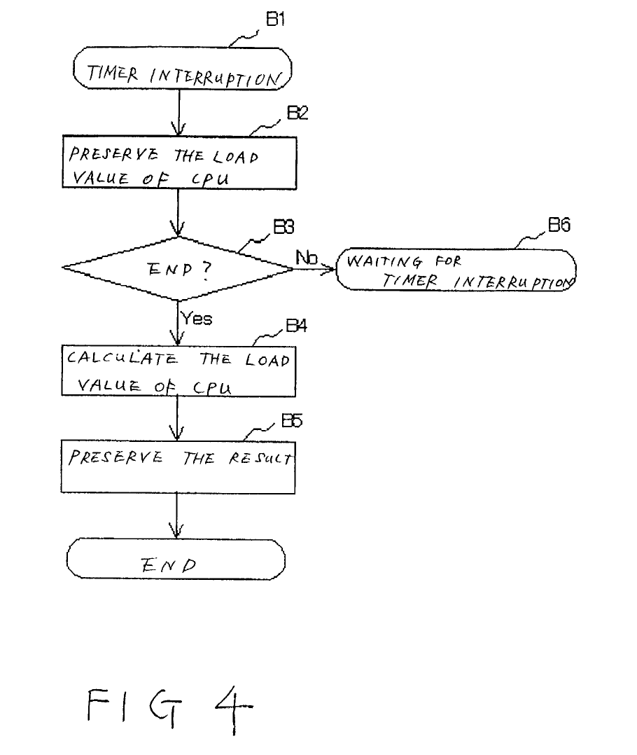

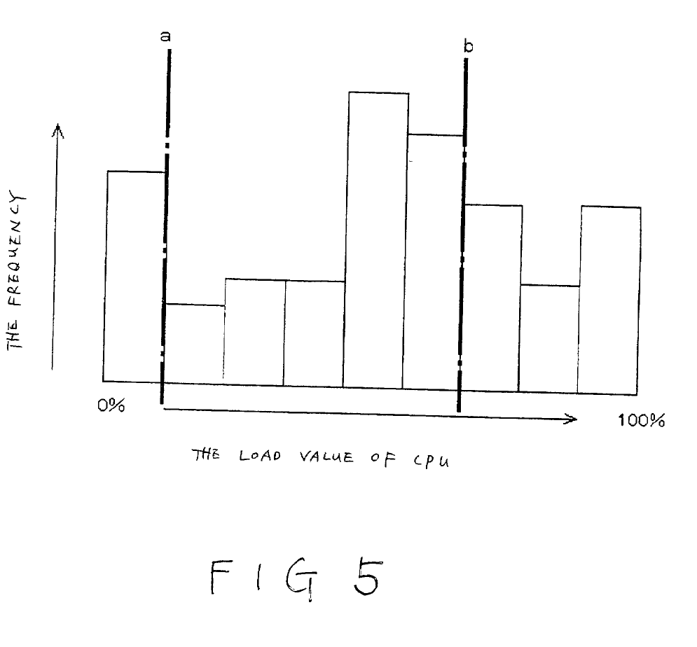

The embodiment of the present invention will now be described more in detail, with reference to FIG. 1 through FIG. 5. FIG. 1 is a diagram for showing the composition of an instrument exchanging system in a preferred embodiment of the present invention. FIG. 2 is a diagram for showing the composition of the terminal of an arrangement center. FIG. 3 is a diagram for showing the process of an instrument exchanging method in the preferred embodiment. FIG. 4 is a flow chart for showing the operation of performance evaluation program provided to the user. FIG. 5 is a diagram for showing an example of the load condition of CPU.

As shown in FIG. 1, the instrument exchanging system in the preferred embodiment of the present invention comprises a plurality of user terminals (for the brevity of explanation, the case of only the user A terminal 10 of the user A and the user B terminal 20 of the user B is considered), the arrangement center terminal 30, the delivery center terminal 40, the recycling processing center terminal 50, and the communication network 100, such as the Internet, and the like, which connects these mutually.

The user A terminal 10 and the user B terminal 20 are information processing equipments, such as personal computer, and the like. The user A terminal 10 and the user B terminal 20 are used by the users. The user A terminal 10 and the user B terminal 20 have functions to get access to guiding information provided on the communication network 100 by the arrangement center terminal 30 and to download the performance evaluation software, respectively. Further, the user A terminal 10 and the user B terminal 20 have functions to transmit the desired condition and the evaluating result of the performance evaluation software as the exchange proposing information to the arrangement center terminal 30 through the communication network 100, respectively, in a case that the user wants to exchange the instrument.

As shown in FIG. 2, the arrangement center terminal 30, which is used by an arrangement center, is composed of an information processing apparatus, such as a workstation server, and the like. In response to the demand from the user terminal, the arrangement center terminal 30 has a function (providing means 31 for providing the performance evaluation software) to transmit the performance evaluation software to the user terminal through the communication network 100. Further, the arrangement center terminal 30 also has a function (instrument selecting means 32) to receive exchange proposing information from a plurality of the user terminals, to calculate proposed specifications of a suitable level, and to transmit the proposed specifications to the corresponding user terminal. Further, the arrangement center terminal 30 has a function (producing means 33 for producing information of exchanging condition) to produce the information of exchanging condition and transmit the produced information to the recycling processing center terminal 50, when the approval to the proposed specifications is received from the user terminal. In addition, the arrangement center terminal 30 has input and output means 34.

The information of exchanging condition includes information for specification of PC which should be delivered to each user, information regarding which user's PC should be delivered, which user should receive the delivered PC, and whether PC to be disposed is existing or not. Moreover, the arrangement center has a function to receive the notice of completion from the recycling processing center terminal 50 and to carry out settlement-of-accounts processing to the user.

The recycling processing center terminal 50 is used by a recycling processing center. Upon receiving the information of exchanging condition, the recycling processing center in which the recycling processing center terminal 50 is located carries out arrangement of new PC, if necessary, management of the stock, and decision of appointed date of delivery. The recycling processing center terminal 50 has function to transmit the delivery directions and the directions of taking over the PC to the delivery center terminal 40. The delivery directions include the information of directing the stocks in the recycling processing center which should be delivered, and the information of identifying the user with which exchange of PC is done. Further, the directions of taking over the PC include the information of directing the user from which the PC should be taken over. Moreover, the recycling processing center has a function to take over the PC from the user, to inspect the PC, and then to transmit the notice of completion from the recycling processing center terminal 50 to the arrangement center terminal 30, if there is no problem as the result of the inspection.

The delivery center terminal 40 is used by the delivery center. The delivery center in which the delivery center terminal 40 is located, upon receiving the delivery directions and the directions of taking over the PC, delivers the stocks in the recycling processing center to a designated user based on these directions, or takes over the PC from the user and then delivers the PC to the recycling processing center.

Next, with reference to FIG. 1 through FIG. 3, the procedure of the instrument exchanging method in the preferred embodiment is explained in detail. In addition, in subsequent explanation, the communication network 100 is assumed as a Internet.

As shown in FIG. 3, the user A gets access to the homepage established on the Internet 100 by the arrangement center through his own user A terminal 10. The user A then transmits the demand of transmission of the performance evaluation software (Step A1). In response to this demand, the arrangement center terminal 30 transmits the performance evaluation software (Step A2). The user A installs the downloaded performance evaluation software in his own PC that the user wants to exchange (It does not ask whether or not the PC is used as a terminal) (Step A3), and then implements the installed performance evaluation software (Step A4). The performance evaluation software resides in the PC in which the performance evaluation software has been installed, monitors the load condition at the time of operation, and records the load condition. While the user A continuously has the performance evaluation software be residing in the PC for arbitrary times, the user A performs the operation on the PC, and preserves the result of the load evaluation by the performance evaluation software (Step A5).

Similarly to the user A, the user B gets access to the homepage of the arrangement center through his own user B terminal 20, transmits the demand of transmission of the performance evaluation software (Step A6). In response to this demand, the arrangement center terminal 30 transmits the performance evaluation software (Step A7). The user B installs the downloaded performance evaluation software in his own PC which the user B want to exchange (It does not ask whether or not the PC is used as a terminal) (Step A8), implements the installed performance evaluation software(Step A9). While the user B continuously has the performance evaluation software be residing in the PC for arbitrary times, the user B performs the operation on the PC, and preserves the result of the load evaluation by the performance evaluation software (Step A10).

After finishing the evaluation by the performance evaluation software, the user A gets access again to the homepage established by the arrangement center through the user A terminal 10. The user A then transmits the demand of transmission of the application document for exchanging the instrument to the user A (Step A11). When the arrangement center terminal 30 receives the demand of transmission of the application document, the arrangement center terminal 30 transmits the data of the application document through the Internet 100 (Step A12). After the user A terminal 10 receives the data of the application document, the user A terminal 10 displays the application document on a screen of the PC (Step A13). Following the format of the document, the user A inputs the required items for the application (name, information address, delivery address, specifications of the PC that is being used now, or the like), and the desired condition for exchanging PC, if needed, (whether the instrument to be extended exists or not). The user A then pushes the transmitting button (Step A14). When the transmitting button is pushed, the user A terminal 10 carries out registration processing (Step A15). The registration processing comprises the steps of creating the application information by combining the required items of the application, the desired condition and the result of evaluation by the performance evaluation software which has already been preserved; and transmitting the application information to the arrangement center terminal 30 through the Internet 100. The arrangement center terminal 30 receives the application information and then preserves the received application information (Step A16).

Similarly to the user A, after finishing evaluation by the performance evaluation software, the user B gets access to the homepage established by the arrangement center through the user B terminal 20. The user B then transmits the demand of transmission of the application document for exchanging the instrument to the user B (Step A17). The arrangement center terminal 30 transmits the data of the application document (Step A18). The user B terminal 20 displays the application document on a screen of the PC (Step A19). Following the format of the document, the user B terminal 20 inputs the required items of the application (name, information address, delivery address, specifications of the PC that is being used now, or the like), and the desired condition for exchanging PC, if needed, (whether or not the instrument will be extended), pushes the transmitting button (Step A20). When the transmitting button is pushed, the user B terminal 20 processes the registration (Step A21). The arrangement center terminal 30 receives the application information, and preserves the application information (Step A22).

When the terminal of arrangements center 30 receives the application information from each user, computes for each user the proposed specifications of the necessary level, in addition the contents of desired condition is considered (Step A23), transmits each user to the proposed specifications (Step A24, A28). If the user want to have the PC which is connectable with LAN apparatus, in addition to the level of the computed specifications of the PC, the specifications which is capable of connecting with LAN apparatus (Such as the port for LAN is loaded) become the proposed specifications.

The terminal of the user A 10 receives the information of the proposed specifications to the user A (Step A25), adds the button whether or not he approves the proposed specifications and displays on the screen (Step A26). If it is judged for the user A 10 that the proposed specifications which is displayed is appropriate, and he wants to exchange the PC of the proposed specifications, pushes “approval button”. When “approval button” is pushed, the terminal of the user A 10 transmits the information of the proposal being approved to the terminal of arrangements center 30 through the Internet 100 (Step A27). When the terminal of arrangements center 30 receives the information of the proposal being approved, registers the contents (Step A32).

Similarly, the terminal of the user B 20 receives the information of the proposed specifications to the user B (Step A 29), adds the button whether or not he approves the proposed specifications and displays on the screen (Step A30). When “approval button” is pushed by the user B, the terminal of the user B 20 transmits the information of the proposal being approved to the terminal of arrangements center 30 (Step A31). When the terminal of arrangements center 30 receives the information of the proposal being approved, registers the contents (Step A33).

After the proposal being approved is obtained by each user, the terminal of arrangements center 30 computes the exchanging condition among the users that the proposal being approved is obtained, transmits it to the terminal of recycling processing center 50 (Step A34). The exchanging condition is checked, whether the PC of specified user may be able to be performed by another user, based on the proposed specifications of each user and the specifications of PC under present use. If possible, the PC of specified user considers as an exchange candidate. For example, if the proposed specifications to the user B is satisfied with the specifications of the PC which the user A has used, the PC of the user B is replaced with the PC of the user A. When another user don't have the PC to be satisfied with the proposed specifications, the stock or new arrangements in the recycling processing center is arranged as the correspondents. Further, if it is the case that the PC of the user which wants to exchange is not satisfied with the proposed specifications of the PC in any other users, it is coped with in the recycling processing center.

In the above-mentioned example which carries the PC of the user A having into the user B, since another user don't have the PC to be satisfied with the proposed specifications of the user A, the stock or new arrangements in the recycling processing center is arranged as the correspondent PC carried into the user A, and the PC which is taken over from the user B is coped with in the recycling processing center.

Therefore, it is the final exchanging condition in this example that the suitable PC for the proposed specifications of the user A is arranged as the stock or new PC, with carried the PC of the user A having into the user B, and the PC of the user B having is coped with taking over.

The recycling processing center receives the exchanging condition in the terminal of recycling processing center 50 (Step A35), arranges the PC carried into the user A in the first place (Step A36). If there is stock in the recycling processing center, it corresponds with stock, and if there is nothing, it is supplied from the outside. When the PC carried into the user A is prepared, the recycling processing center transmits the information for delivery direction to the terminal of delivery center 40 from the terminal of recycling processing center 50 (Step A37). Herein the information for delivery direction in the embodiment have the directions to deliver the PC for the user A which is prepared in the recycling processing center to the user A and take over the PC of the user A having, carry back to the recycling processing center.

Following the information for delivery directions from the terminal of delivery center 40, the delivery center delivers, carries in, and takes over the PC. In this embodiment, the delivery center directs the transport agent to deliver the PC for the user A which is prepared in the recycling processing center to the user A and take over the PC of the user A having, carry back to the recycling processing center (Step A38).

The user A receives the PC which is delivered from the recycling processing center by the direction of the delivery center, and hands over the PC of the user A having to the transport agent (Step A39). Following the direction of the delivery center, the transport agent carries the PC into the recycling processing center (Step A40), it is taken over in the recycling processing center (Step A41).

The recycling processing center inspects the PC of the user A having, inspects whether it is indifferent from the specifications of a report of the original user A, or there is not any trouble (Step A42). If there is no problem as a result of inspection, the notice of completion about the PC of the user A is transmitted to the terminal of arrangements center 30 from the terminal of recycling processing center 50 (Step A43).

When the delivery center receives the notice of completion about the PC of the user A in the terminal of arrangements center 30 (Step A44), settlement-of-accounts processing is performed to the user A (Step A45).

With regard to the user B similarly, when the PC from user A have been taken over and the PC that carried into the user B is prepared, the recycling processing center transmits the information for delivery direction to the terminal of delivery center 40 from the terminal of recycling processing center 50 (Step A46). Herein the information for delivery direction in the embodiment have the directions, which is to carry the PC that the user A have used into the recycling processing center, and deliver it to the user B, and take over the PC of the user B having, carry back to the recycling processing center.

Following the information for delivery directions from the terminal of delivery center 40, the delivery center delivers, carries in, and takes over the PC. In this embodiment, the delivery center directs the transport agent to deliver the PC for the user B which is prepared in the recycling processing center to the user B and take over the PC of the user B having, carry back to the recycling processing center (Step A47).

The user B receives the PC which is delivered from the recycling processing center by the direction of the delivery center, and hands over the PC of the user B having to the transport agent (Step A48). Following the direction of the delivery center, the transport agent carries the PC into the recycling processing center (Step A49), it is taken over in the recycling processing center (Step A50).

The recycling processing center inspects the PC of the user B having, inspects whether it is indifferent from the specifications of a report of the original user B, or there is not any trouble (Step A51). If there is no problem as a result of inspection, the notice of completion about the PC of the user B is transmitted to the terminal of arrangements center 30 from the terminal of recycling processing center 50 (Step A52).

In addition, it is preferable to clean the inside and the exterior, and to do the exchanging work of exhausting parts (such as a battery, back light of LCD) after inspection of Step A42, A51.

When the delivery center receives the notice of completion about the PC of the user B in the terminal of arrangements center 30 (Step A53), settlement-of-accounts processing is performed to the user B (Step A54).

The PC that the user B has used is coped with in the recycling processing center (Step A55).

To be concrete, the PC is kept as stock as it is, or by partially which part is replaced. Moreover the PC is remodeled higher efficient PC in storage, abandoned as disposal, or broken it down apart.

Next, with reference to FIG. 4, the operation of the performance evaluation software is explained. The performance evaluation software resides for predetermined time, investigates periodically the load of CPU by timer interruption, registers it.

To be concrete, as shown FIG. 4, if there is timer interruption (Step B1), the load value of CPU at the time is investigated and it is recorded on a memory (Step B2). If the end conditions (such as the progress of predetermined time, the selection of an end menu) which the user set up are not fulfilled, it returns to the waiting conditions for timer interruption (Step B3). While end conditions are fulfilled, the data recorded by then is totaled such as every 10% (Step B4), the result is recorded on a file (Step B5), and it ends.

Next, with reference to FIG. 5, the computation method of suitable specifications level of the PC is explained. In FIG. 5 the distribution of loading CPU of the user is shown, which is computed by the performance evaluation software. Herein 0% shows the state where CPU is not used at all, 100% shows the state where all CPU resources are used.

When the idling states continues, such as the waiting for inputting, since PC loads CPU near 0%, the whole frequency is computed except for below the threshold value a. While the rate of the frequency beyond the threshold value b is computed, which is the domain of high loading of CPU. If this rate is certain value c or more, it is considered as the higher performance CPU is needed.

The necessary performance of CPU for both the rate of the high loading domain and the amount of the user operating is computed, may be made the tables by experiment beforehand. Referring to the tables as the key to the rate of the high loading domain of CPU, at the time of the performance evaluation software is operating, under the user circumstance it is capable of computing how much performance of CPU is needed. At the moment the used amount of the memory and the used amount of hard disk besides the loading value of CPU is computed, it is preferably to be the base of computing the proposed specifications for the user.

In addition, in the above-mentioned embodiment, shown in only the case that the user exchange the PC. however, before providing the user with the PC, it may be performed to extend an instrument (addition of expanded card, and the like) in response to the demand. Further, at the moment of carried the PC into the user, it may be performed to operate setting up of the PC in response to the demand.

Moreover, the above explanation was made about an example for exchanging the PC, the present invention is not restricted to the above embodiment. The present invention can be applied to any instruments that the performance thereof are improved year after year and that should be exchanged to another one of higher performance at an adequate timing, for example, a portable terminal equipment, such as a portable telephone, a mobile instrument, and the like.

What is claimed is:

1. An instrument exchanging system comprising:
an user terminal of an user which owns an instrument that the user wishes to exchange;
an arrangement center terminal of an arrangement center which arranges the exchange of said instrument;
a recycling processing center terminal of recycling processing center which supplies the instrument to exchange;
a delivery center terminal of a delivery center which collects the instrument owned by said user and delivers the instrument to exchange,
at least said user terminal, said arrangement center terminal, said recycling processing center terminal and said delivery center terminal being connected through a communication network;
said arrangement center terminal further including: at least
receiving means for receiving the performance evaluation information of said instrument obtained by performance evaluation program for evaluating performance of said instrument and the information inputted by said user;
producing means for selecting an instrument of a performance suitable for each user's using condition and producing the exchanging condition information with reference to the performance evaluation information and the inputted information of a plurality of users; and
providing means for providing said user with the exchanging condition information.

2. An instrument exchanging system as claimed in claim 1, wherein said performance evaluation program is transmitted from said arrangement center terminal to said user terminal or is supplied to said user with a manner being recorded in a recording medium and is carried out in said instrument owned by said user.

3. An instrument exchanging system as claimed in claim 1, wherein said performance evaluation information includes the load value of CPU of said instrument or the used amount of memory means of said instrument.

4. An instrument exchanging system as claimed in claim 1, wherein said inputted information includes information of extended function that the user wishes.

5. An instrument exchanging system as claimed in claim 1, wherein said instrument is a computer instrument or a portable terminal.

6. An instrument exchanging method for use in a system in which at least an user terminal of an user which owns an instrument that the user wishes to exchange and an arrangement center terminal of an arrangement center which arranges the exchange of said instrument are connected through a communication network, said method comprising the steps of:
receiving an instrument exchanging demand from said user;
receiving the performance evaluation information of said instrument obtained by performance evaluation program for evaluating performance of said instrument and the information inputted by said suer;
selecting an instrument of a performance suitable for each user's using condition and producing the exchanging condition information with reference to the performance evaluation information and the inputted information of a plurality of users;
providing said user with the exchanging condition information;
said receiving an instrument exchanging demand step, said receiving the performance evaluation information step, said selecting an instrument of a performance suitable for each user's using condition and producing the exchanging condition information step, and said providing said user with the exchanging condition information step being carried out by said arrangement center terminal; and
when said user has consented to said exchanging condition, said exchange of said instrument is carried out.

7. An instrument exchanging method as claimed in claim 6, wherein said arrangement center transmits said performance evaluation program from said arrangement center terminal to said user terminal or supplies said user with said performance evaluation program in a manner being recorded in a recording medium.

8. An instrument exchanging method as claimed in claim 6, said method being for use in said system in which a recycling processing center terminal of a recycling processing center which supplies the instrument to exchange and a delivery center terminal of a delivery center are further connected through a communication network, wherein said recycling processing center newly arranges the instrument, when the exchange is not materialized between the instruments which a plurality of users offer, and when corresponding instrument in this recycling processing center is not being kept, and wherein said delivery center collects the instrument owned by said user and delivers the instrument to exchange.

9. An instrument exchanging method as claimed in claim 6, wherein said performance evaluation program is implemented by the user who obtained this performance evaluation program on the instrument which the user wishes to exchange during predetermined time, and wherein the using condition of the instrument being supervised and memorized by the performance evaluation program, and the performance evaluation information is produced.

10. An instrument exchanging method as claimed in claim 6, wherein said performance evaluation information includes the load value of CPU of said instrument or the used amount of memory means of said instrument.

11. An instrument exchanging method as claimed in claim 6, wherein said inputted information includes information of extended function that the user wishes and wherein said arrangement center selects the instrument with reference to said information of extended function.

12. An instrument exchanging method as claimed in claim 6, wherein said instrument is a computer instrument or a portable terminal.

13. An instrument exchanging service for use in combination with the instrument exchanging method as claimed in claim 6, wherein said performance of instrument which the user wishes to exchange is automatically evaluated by the instrument exchanging method, and the instrument suitable for the using condition of the user is proposed, and the instrument owned by the user is collected on the occasion of exchanging the instrument.

14. A performance evaluation program for making a computer carry out the processing comprising: within a predetermined time, monitoring the load condition of CPU; collecting frequency distribution of the load condition of CPU after said predetermined time has passed; calculating frequency of the load condition of CPU exceeding the threshold; determining performance of CPU in correspondence to a predetermined user's operating condition with reference to the calculated value and a predetermined table.

15. A performance evaluation program as claimed in claim 14, wherein said table comprises a correspondence table of the required performance of CPU calculated by experiment with the rate of load condition exceeding the predetermined threshold value.
